(19) United States
(12) Patent Application Publication
(10) Pub. No.: US 2005/0108279 A1
(43) Pub. Date: May 19, 2005

(54) Method and dynamic system for the mangement and production of technical documentation in a database

(76) Inventor: Andrea Di Giuliani, Genova (IT)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/497,132

(22) PCT Filed: Nov. 22, 2002
(86) PCT No.: PCT/IB02/05086

(30) Foreign Application Priority Data
Nov. 30, 2001 (IT) MI01A002535

(51) Int. Cl. G06F 17/00

(52) U.S. Cl. 707/103 R

(57) ABSTRACT

An object oriented approach for the management of components of technical documents related to products involves seeing each product as an object and each object possessing a set of well prescribed and simple operations which can operate on it and are termed “methods” (for example, “install”, “update”, “save”, “layout”, etc.). With such an organization each technical procedure is merely a list of components where a component represents the association of an object with the associated method. Once the database of the components is developed, it is possible to obtain the desired technical procedures merely by combining the existing components with each other in different sequences. It will be necessary to develop a new component only when the procedure requires something new and this component will be available for future procedures.

The present invention relates to a method and a dynamic system for the management and production of technical documentation and in particular documentation describing technical procedures to be applied in an industrial environment on software or hardware/software products.

The quality of client support services in complex industrial environments is worsening because of technical documentation development, maintenance and utilization problems. In particular, by the expression ‘complex industrial environments’ may be understood industrial environments in possession of complex and high-tech products which are developed in a worldwide environment in different sites and by different groups (sometimes of different controlled companies) and with the need of technical management of hundreds of customers thanks to internal customer support structures at multiple levels. Usually these firms also have a dynamic R&D department able to release many product versions each year and fast technology growth implying necessarily many differences in terms of functionality and design of architecture with every version of a product.

With such premises, when a new version of software is distributed a new set of documents must be completely written, encoded and authorized even if the associated procedures have changed little.

To complicate matters the technical documentation is generally generated by different independent groups, each using its own styles, electronic formats, updating intervals et cetera. This causes the procedure to be developed many times or similar procedures sharing many parts are written over uselessly with the negative aspect of creating an enormous amount of redundant documents with the associated multiplication of time and effort.

All this necessitates much effort and makes the data base of technical documentation ever greater without adding real value thereto.

To attempt to reduce the number of documents general procedures are usually created which are capable of managing various versions of the same product but this increases the complexity of the individual documents and makes them difficult to read.

The management problems of great masses of interrelated documents cause delay in the generation of the new documentation or maintenance of the existing documentation and this leads to additional problems such as the proliferation of redundancies in the documentation (for any procedure there are usually various documents with different authors, versions, writing styles, formats and content) and difficulties for users in tracing the latest updated version of the desired document.

In such a situation the developers are deeply dissatisfied because they spend the greater part of their time producing documentation without adding real knowledge. What changes is often only the version number in the document title.

On the other hand the users are ever angrier because they spend much time tracing for the right version of the document and trying to filter its unnecessary complexity. They usually spend more time than necessary in applying the procedures because in the attempt to be general in order to handle different versions or products the associated documentation is necessarily complicated. The documents that were made suitable for use with several versions of a product usually display parts like, ‘If the product is MV36 version 11 carry out the following operation . . . , otherwise, if the product is MV36 version 12, then . . . , otherwise if it is MV36 version 13 it is necessary . . . et cetera’. Under these conditions the user thinks, ‘Why all these cases, I'm only interested in product MV36 version 13’. This kind of complication increases with the number of versions of a product; what will happen when product MV36 version 99 is marketed?

To complicate things, users typically don't know which is the last revision of the document they require or, still more often, they don't know at all which is the right document they require because of the amount of redundant documentation available.

All the above aspects lead to a generalized worsening of the level of customer support in terms of time and quality expended to fulfil the required service. It is thus seen that a new approach to procedure management is needed to solve the problem at the roots once and for all.

The general purpose of the present invention is to remedy the above mentioned shortcomings by making available a new and innovative methodology to optimise, rationalize, simplify and accelerate documentation handling starting with production and through to distribution to end users.

In view of this purpose it was sought to provide in accordance with the present invention a method for the building and management of a technical documentation database of technical procedures applied to products and production of such documentation from the database content including the steps for building of the database of dividing them in a set of elementary parts termed methods, creating a hierarchy of objects where each object relates to a particular product or product version, associating with the objects the methods for that particular product and in the hierarchy of objects the objects at the lower levels of the hierarchy being able to inherit methods from the objects at higher levels of the hierarchy, associating with each technical procedure the production of which it is wished to enable an orderly list of components realizing the procedure where one component represents the association between an object and the associated method, memorizing the database of the components and the procedure lists, including the following steps for the automatic creation of documents: extraction from the database of the list of the procedures associated with the required document, extraction in an orderly manner from the database of the method associated with the object for each component of the list, if the method does not exist for the associated object checking whether the method has been finalized for the parent object or the one nearest in the hierarchical tree of the objects, repetition of the above step until the method is found or the root of the object hierarchy is reached, assembly of the methods in the order established by the procedure list, and viewing the document thus obtained.

Again in accordance with the present invention it was sought to realize a system for the production and management of technical documentation of technical procedures applied to products including a database for storage of a set of elementary document parts termed methods in a hierarchical set of objects where each object relates to a particular product or product version and with each object are associated the methods for that particular product, with memorizing means memorizing for each technical procedure of which it is wished to enable production an orderly list of components which realize the procedure where one component represents the association between an object and the associated method, means of extraction and creation from the database of a procedure document which receive at input parameters describing the required procedure, extract from the memorization means the list associated with said procedure and for each component of this list extract in an orderly manner from the database the associated method representing an elementary part of the procedure, arrange in order the elementary parts extracted, and show the document obtained by the assembly of such elementary parts.

To clarify the explanation of the innovative principles of the present invention and its advantages compared with the prior art there is described below with the aid of the annexed drawings a possible embodiment thereof by way of non-limiting example applying said principles. In the drawings:

FIG. 1 shows a block diagram of a system in accordance with the present invention,

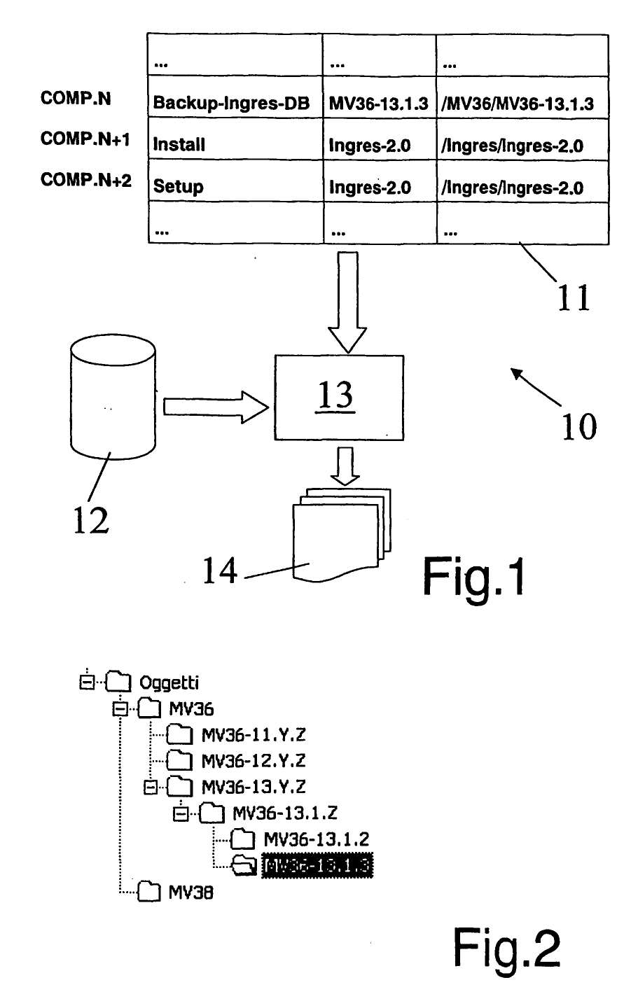

FIG. 2 shows a folder and subfolder structure of an object database in accordance with the present invention, and

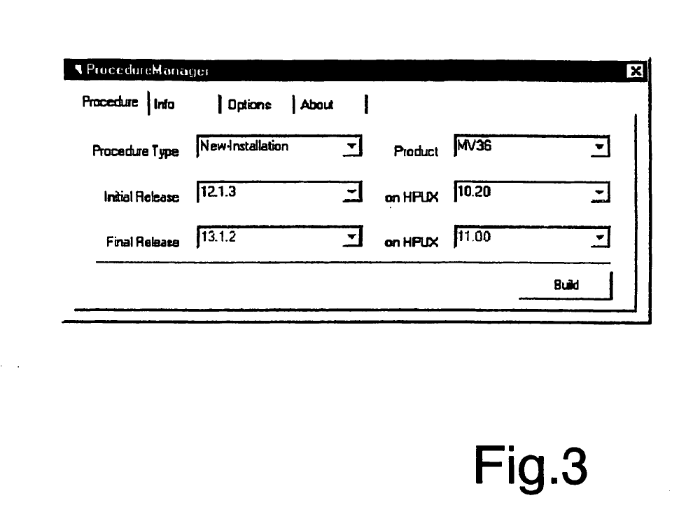

FIG. 3 shows a window of a user interface.

With reference to the FIGS FIG. 1 shows a system designated as a whole by reference number 10 for the management of technical documentation which generates technical procedure documents in particular for the maintenance, management, updating and installation of software. The present invention is based on the observation that despite the complexity reached by technical documentation many documents are theoretically simple because they share pieces (which can be termed ‘code’) already described in other documents without or with small added value.

In accordance with the present invention the technical documentation is therefore shared in a set of elementary ‘bricks’ (methods) which are simple reusable documents describing standard operations such as for example installation, layout, saving et cetera.

The methods are elementary parts of documents and are thus documents with characteristics of independence (their operational sense is clear even if analysed individually) and reusability (they are used repeatedly by several procedures).

Then a hierarchy of objects is created where each object relates to a particular product.

With the objects are associated the methods for that particular product. In the object hierarchy the objects at the lower levels in the hierarchy can inherit methods from the objects at the higher levels of the hierarchy. With a parallel to object programming, it can be said that a collection of objects is created which supports the concepts of polymorphism and hereditariness. There is thus a hierarchical tree with parent objects and offspring objects.

In other words, with an object oriented approach for the management of components of technical documents related to products each product (for example MV36, MV38 . . . et cetera) is seen as an object and each object possesses a set of well prescribed and simple operations which can operate on it and are termed ‘methods’ (for example, ‘install’, ‘update’, ‘save’, ‘layout’ et cetera). With such an organization each technical procedure is merely a list of components where a component represents the association of an object with the associated method (for example, Setup MV36). Once the database of the components is developed it is possible to obtain the desired technical procedures merely by combining the existing components with each other in different sequences. It will be necessary to develop a new component only when the procedure requires something new and this component will be available for future procedures.

In the specific implementation it was found advantageous to realize the object database as shown diagrammatically in FIG. 2. In this realization each product is represented by a folder. Each folder contains in turn sub-folders (which are offspring objects of the parent folder containing them) related to different versions of methods associated with that product. A method made up of a file placed in a particular folder operates on the associated product and on all the product versions represented by its sub-folders. In other words the files (methods) contained in a folder can be associated with the object associated with the folder and with all the offspring objects associated with its sub-folders.

It is explained below how this structure is particularly advantageous for the management simplicity it allows.

In accordance with the present invention, by creating a hierarchy of elementary objects the memorized procedures become merely a list of components memorized in memorization means 11 such as a hard disk memorizing also the object database in the form of a particular table (FIG. 1). Each procedure is represented as an orderly list of components where any component is identified by the name of a method, the object on which the method operates and, if database 12 of the objects has a structure as mentioned above, the path of the objects containing the object. List and objects (components) can be inserted in a single database. It should be noted that each component (or method) is virtually a text realized in a chosen form, for example a text in Microsoft Word™ format.

For example, FIG. 1 shows a table for a procedure concerning the updating of the product MV36 from the version 11.1.5 to the version 13.1.3 and described by a document with a certain number of components and with the nth component formed by the method called “Backup-Ingres-DB” of the object MV36-13.1.3 and which is found in /MV36/MV36-13.1.3, the component n+1th made up of the “Install” method of the object Ingress-2.0 and which is found in /Ingres/Ingres-2.0 et cetera.

The system includes means 13 for the generation of procedures which receive at input the user's request, retrieve the right table 11 describing the components of the procedure needed by the user and combine the components described by the table taking them from the object database 12. Document 14 describing clearly the entire procedure is thus generated.

The procedure generator 13 is virtually an intelligent user interface, called here Procedure Manager (PM) which asks the user for some parameters such as for example the type of procedure, product name, operating system version et cetera, loads with run-time the required components by connecting with a remote server containing the object database, creates the required procedure by merging the necessary components, and shows the procedure using a suitable standard document management program, for example the known Microsoft Word™.

The rule used by Procedure Manager for loading the components associated with the related products is in accordance with object oriented logic the following.

If the component (method) prescribed for the object required exists it is loaded.

Otherwise PM looks for the component (method) in the higher object. This process is repeated automatically during loading of any procedure until the required component is found or the root object is reached. Therefore the above mentioned application of the polymorphism and hereditariness concepts are seen. There could be many implementations of the same method but any product version inherits those prescribed in the higher folder.

The time that has to be spent on maintaining and developing components is very low.

Assume that a new version of a product and the associated procedures are mostly the same as the previous version except for some methods which have to be modified in the documentation.

In accordance with one aspect of the present invention it is sufficient that the developer of the procedure place a new folder in the product folder and insert in this new folder the new implementation of the methods which will have to be modified in the new procedure with respect to the old procedure. When the user requires the procedure for the new product, PM will use the new methods because they are more specific with respect to the methods prescribed in the higher folder. For those methods which have not been rewritten for the new product, when the user asks for the procedure of the new version of the product PM will not find these methods in the new folder and will automatically load the more general methods prescribed in the higher folder.

As an example assume that at the beginning a component called for example, “Convert-Objectivity-DXC-DB” was prescribed at the level of product MV36. The product version designated MV36-11 and the product version MV36-12 both share this component. Now assume that a new product version called Mv36-13 is released and that for this new version the component “Convert-Objectivity-DXC-DB” has to be implemented in a different way.

It suffices to create a new folder called MV36-13 as a sub-folder of the folder MV36 and put in it the new implementation of the component “Convert-Objectivity-DXC-DB”. When a procedure related to MV36-13 is required, PM automatically loads this implementation of the component because it is the most specific with respect to the one prescribed at the higher level MV36. No modification of the preceding code is required but it is necessary only to add the missing methods and the methods which have to be applied.

Similarly, if a new modification of MV36-13 is then supplied to implement the function “Convert-Objectivity-DXC-DB” in the same manner as the previous version it suffices to remove “Convert-Objectivity-DXC-DB” prescribed at the level Mv36-13. When a procedure related to MV36-13 is required, PM loads the old implementation of “Convert-Objectivity-DXC-DB” prescribed at level MV36 since the specific implementation prescribed for MV36-13 no longer exists. Once more, no modification of the code is necessary but it is only necessary to remove the specific component.

This method is clearly applicable to any level of detail. For example (see FIG. 2) assume that a new sub-version of the product MV36-13 called for example MV36-13.1.2 is released. Assume also that the implementation of the component called “Convert-Objectivity-DXC-DB” has been generically prescribed at the level of product MV36 but that MV36-13.1.1 requires a new implementation for that component.

Thus it is again wished to prescribe a new object for managing a new product. Under these conditions it is not necessary to modify the base of the existing component because a new folder MV36-13.1.2 is merely prescribed in the folder MV36 and then the new implementation of the component is added to it. PM will automatically load the new implementation of the component when necessary because it is more specific than the implementation prescribed at the level of folder MV36.

In another case assume that a new patch was added to a certain version of a product, for example MV36-13.1.2, to make possible the implementation of a certain operation, for example again the one called “Convert-Objectivity-DXC-DB”, in the same manner as the implementation of the operation in the preceding version. The database developer can manage this by merely removing the component “Convert-Objectivity-DXC-DB” from the folder MV36-13.1.2. The PM will automatically load the implementation of “Convert-Objectivity-DXC-DB” prescribed in the folder MV36 because this is the next higher object of MV36-13.1.2 which no longer contains the component “Convert-Objectivity-DXC-DB”.

It is thus seen that it is always possible to handle novelties without touching the pre-existing code. This makes the process of maintaining the database of components easier and faster.

From the user's viewpoint, to load and view the requested procedure the user only has to introduce some simple parameters to prescribe which procedure he is interested in.

An advantageous embodiment of the present invention for the end user is described below. In this advantageous embodiment, before starting the procedure construction process it is necessary to set the following parameters in a window of the user interface (FIG. 3).

PROCEDURE TYPE: This parameter designates the class of the procedure it is desired to load and can take on one of the following values.
New Installation: the procedures belonging to this class describe the steps which must be realized to install any product on a server not having any previous installation of the product.
Software updating: the procedures belonging to this class describe the steps which must be realized to update any product and the associated database on a server equipped with any previous installation of the product.
Database porting: the procedures belonging to this class describe the steps which must be realized to move any database of a product from a server with a certain version of the product to another server with a more recent version of the product. The operations necessary for conversion of the database to make it compatible with the new version of the product are also described in this class.
Spare updating: the procedures belonging to this class describe the steps which must be realized for updating any product and the associated database on a server equipped with a previous installation of the product using an additional supporting server. This class of procedures is necessary when the updating is particularly complicated, for example when updating of the operating system is required and the normal software updating procedures are not applicable.

PRODUCT: This parameter designates the type of product the procedure will have to manage, for example MV36, MV38 et cetera.

INITIAL RELEASE: This parameter designates the version of the product before applying the steps described by the procedure, for example 11.1.5, 12.1.2 et cetera.

FINAL RELEASE: this parameter designates the version of the product after applying of the steps described in the procedure. It is noted that this is not required when a ‘new installation’ class procedure is to be loaded.

At the right of the Initial Release and Final Release fields is an ‘on HPUX’ field which is used for specifying which operating system version the respective product release works on. In the example described here reference is made to the known operating system HPUX.

After entering the parameters the user only has to select the Build button to view a document describing the entire required procedure and which can be conveniently be printed later.

It is now clear that the predetermined purposes have been achieved by dividing the entire document base in a set of simple, well prescribed, independent and reusable pieces of code called components. By combining these components in a particular sequence and order depending on the end user's requirements, the original procedures are obtained automatically. The end user must only supply a few required parameters.

The procedures generated are similar in content to the old ‘sculptured’ procedures but display more standardized format, style and flow control because the components are written only once even if they are shared by a plurality of procedures.

In addition the component database can be useful for generating new procedures by merely combining existing components in a new sequence without having to actually write new documentation. Only in the worst case when no component exists to describe a certain operation of the new procedure it might be required to write a new component. It is clear that when the component database is sufficiently supplied the activity of creating a new component is minimal and in any case adds knowledge and value to the component database because a new component will be useful not only for the procedure for which it is created but also for future procedures.

When applying the principles of the present invention the advantages are immediate. Users are happy because they can concentrate on applying the procedures because access to documentation is easy at any place and time and they need not worry about retrieving the latest updating of the required documentation since the components are loaded in runtime and are therefore by definition always updated to the latest available version. Furthermore only the necessary components are loaded and this shortens and simplifies the procedure supplied.

Developers are also happy because they can concentrate on adding real value to the documentation because they can reuse the existing components as much as possible for the construction of new procedures and dedicate themselves to the construction of new components only when a new operation has to be managed or when an existing operation is to be implemented in a different way. Developers can focus their attention on only what is really changed to produce more detailed procedures with little effort.

Procedures can also be kept completely updated in a very simple manner. When any procedures developer finds an error in any method he merely changes it and all the procedures requiring that method are automatically updated without further effort. Run-time loading of required components of a procedure from a remote database then allows updated procedures to be immediately available to end users anywhere and in any way.

In addition, the innovative principles of the present invention provide various other advantages among which is the guarantee against unauthorized circulation of documents thanks to the adoption of a centralized database for storing technical procedures.

Naturally the above description of an embodiment applying the innovative principles of the present invention is given by way of non-limiting example of said principles within the scope of the exclusive right claimed here. For example management of the database and creation of objects can draw advantage from a web based client/server for use over an intranet.

1-12. (canceled)

13: A method of building and managing a technical documentation database of technical procedures applied to products, and of producing documentation from the database, comprising the steps of:
a) dividing the documentation into a set of elementary methods;
b) creating a hierarchy of objects where each object relates to a particular product;
c) associating with the objects the methods for that particular product, the objects at lower levels of the hierarchy being able to inherit methods from the objects at higher levels of the hierarchy;
d) associating with each technical procedure an orderly list of components for realizing the technical procedure, one component representing an association between one of the objects and the associated method;
e) storing the components and the procedure lists in the database; and
f) automatically creating the documentation by
i) extracting from the database the procedure list for the required documentation,
ii) orderly extracting from the database the method associated with the object for each component of the list and, if the method does not exist for the associated object, checking whether the method has been finalized for a parent object or one nearest in the hierarchy of the objects,
iii) repeating the orderly extracting step until the method is found or a root of the object hierarchy is reached, and
iv) assembling the methods in an order established by the procedure list, and viewing the documentation thus obtained.

14: The method in accordance with claim 13, in which the methods are elementary parts of the documentation, the elementary parts having a clear operational sense and being reusable.

15: The method in accordance with claim 13, in which the objects in the database are represented by a hierarchical tree of folders, and the hierarchy is established by inserting sub-folders representing offspring objects within the folders representing the parent objects, each folder containing in addition a series of files representing the methods to be associated with the object related to the folder and all the offspring objects related to its sub-folders.

16: The method in accordance with claim 13, in which the products are software products and the technical procedures include operations of installation, layout, saving, updating and uninstalling of the software products.

17: A system for producing and managing technical documentation of technical procedures applied to products, comprising:
a) a database for storing a set of elementary document parts termed methods in a hierarchical set of objects, each object relating to a particular product, and each object being associated with the methods for that particular product;
b) means for memorizing for each technical procedure an orderly list of components for realizing the technical procedure, one component representing an association between one of the objects and the associated method; and
c) procedure document database extraction and creation means for receiving input parameters describing a required technical procedure, for extracting from the memorizing means the list associated with the technical procedure and, for each component of this list, for extracting in an orderly manner from the database the associated method representing an elementary part of the technical procedure, for arranging in order the elementary parts extracted, and for showing the documentation obtained by assembly of the elementary parts.

18: The system in accordance with claim 17, in that the elementary parts are elementary parts of documents, the elementary parts having a clear operational sense and being reusable.

19: The system in accordance with claim 17, in that the objects in the database are represented by a hierarchy of folders, and the hierarchical set is established by inserting sub-folders at lower levels in the hierarchy in folders at higher levels of the hierarchy, the methods of an object being made up of files memorized in the folder representing that object.

20: The system in accordance with claim 17, in that the extraction and creation means operate so that, if they do not trace in the database the method prescribed for a required object, they seek the method in progressively higher objects in the hierarchical set of objects until the method is traced or a root object of the hierarchical set of objects is reached.

21: The system in accordance with claim 17, in that the products are software products, and the input parameters include a first parameter (PROCEDURE TYPE) designating a class to which the desired technical procedure belongs, a second parameter (PRODUCT) designating a type of product the technical procedure will have to manage, a third parameter (INITIAL RELEASE) designating a product version before applying the steps described in the technical procedure and, if necessary, a fourth parameter (FINAL RELEASE) designating the product version after having applied the steps described in the technical procedure.

22: The system in accordance with claim 21, in that the first parameter is chosen from among values indicating the technical procedure for a new product installation, the technical procedure for updating an existing product version, a porting version of a database of the product, and a spare updating procedure of a database of the product which uses a support computer in addition to the one to be updated.

23: The system in accordance with claim 17, in that the products are software products, and in that the technical procedures include operations of installation, layout, saving, updating and uninstalling of the software products.

24: The system in accordance with claim 17, in that the object database and the list memorizing means are inserted in a single database of components and procedure lists.
